(19) United States
(12) Patent Application Publication
(10) Pub. No.: US 2007/0181382 A1
(43) Pub. Date: Aug. 9, 2007

(54) Elevator car and method of installing wall elements of a car wall

(76) Inventor: Denis Sittler, Illzach (FR)

Correspondence Address: Klaus P. Stoffel;Wolff & Samson PC, One Boland Drive, West Orange, NJ, 07052, US

(21) Appl. No.: 11/637,313

(22) Filed: Dec. 12, 2006

(30) Foreign Application Priority Data
Dec. 13, 2005 (EP) 05112016.0

(51) Int. Cl. B66B 11/02

(52) U.S. Cl. 187/401

(57) ABSTRACT

In an elevator car with adjacently arranged wall elements, there are present in the area of adjacent end-faces of the wall elements two joining elements of which one is fixed on a principal surface of a first wall element and one on a principal surface of a second wall element that lies in the same plane. Each of the joining elements also overlaps the principal surface of the wall element on which it is not fixed. One of the joining elements has a diagonal bounding surface and the other joining element has an opposite contour which on alignment of the wall elements slides on the diagonal bounding surface.

### BACKGROUND OF THE INVENTION

The invention relates to an elevator car with at least one car wall that comprises at least two wall elements arranged adjacently, a method for installing such wall elements, and an elevator with an elevator car according to the invention or with an elevator car whose wall elements are installed by the method according to the invention. The invention relates to the problem of installing several adjacently arranged wall elements of an elevator car flush with each other and with no gap or with a gap of defined width.

From U.S. Pat. No. 4,430,838, a device for the mutual alignment and joining of two adjacently arranged wall elements is known which according to the description is used inter alia in the construction of elevator cars. As illustrated in FIGS. 4, 5, and 6, the device comprises several pairs of panel-shaped aligning elements and a joining element. Each first aligning element of a pair is fastened to a principal surface of a first wall element and the second aligning element is fastened to the corresponding principal surface of the second wall element, when aligning the two wall elements both aligning elements overlapping the respective principal surface of the wall element to which they are not fastened. The aligning elements ensure that the principal surfaces of adjacent wall elements always align perfectly flush with each other when being installed and in the installed state. By means of the joining element, the two wall elements are pressed against each other in the area of their adjacent end-faces and fixed in this position. Present in the joining element are diagonally arranged slits that act in conjunction with pins projecting from each of the wall elements in such manner that movement of the joining element causes the mutual bracing and fixing of the wall elements.

The device for joining adjacently arranged wall elements that is disclosed in U.S. Pat. No. 4,430,838 has certain disadvantages. The most important disadvantage is that during installation of the wall elements, the joining point with the joining element must always be accessible to an installation person. This is necessary firstly, so that after the lateral mutual alignment of the wall elements the joining element can be fastened to the latter in such manner that the pins that are present in the wall elements project through the respective corresponding diagonal slits and secondly, so that the joining element can be moved in the direction of its slits to subsequently brace and fix the wall elements. Since practical reasons make it impossible for the aligning and joining elements to be fastened on the side of the wall elements that faces the inside of the elevator car, the joining of the wall elements can only take place from outside the elevator car. In modem elevator systems, however, the distance between the elevator car and the walls of the elevator hoistway is so small that the device disclosed in U.S. Pat. No. 4,430,838 cannot be used.

A further disadvantage of this device is to be seen in that it comprises three different components, namely the aligning elements, the pins, and the joining element. These components are complicated to manufacture and require substantial logistical outlay, since at least the joining elements must be delivered separately. Fastening the pins onto the wall elements requires much time and great accuracy.

The device according to U.S. Pat. No. 4,430,838 also has the disadvantage that it only allows joining of the wall elements without an intervening gap. To obtain adequate ventilation of the elevator car, it can be expedient to install adjacent wall elements with an intervening gap whose width is several millimeters.

### SUMMARY OF THE INVENTION

The object of the present invention is to provide an elevator car with a car-wall construction that does not possess the disadvantages of the device that is cited above as the state of the art. In particular, therefore, an elevator car shall be created whose wall elements can be installed and joined together from inside the elevator car, the device for joining and aligning the wall elements not being fastened to the side of the wall elements that faces the interior. It shall also require a smallest possible number of components, these components being inexpensively manufacturable and advantageously not forming a separate logistical item, i.e. not being stored, ordered, delivered and installed as separate components. In addition, for the mutual alignment and joining of the wall elements, the device shall also enable simple and time-saving installation of the wall elements with or without a gap between them.

The problem is solved by an elevator car, by an elevator system with such a car, and by a method according to the present invention.

In an elevator car according to the invention, adjacently arranged wall elements are joined by at least one joining device that comprises two joining elements arranged one above the other. A first one of the joining elements is fixed on a principal surface of a first wall element and a second one of the joining elements is fixed on a principal surface of a second wall element that lies in the same plane. Each joining element also overlaps the principal surface of the wall element to which it is not fixed. One of the joining elements has a bounding surface that runs diagonal to the lengthwise direction of the adjacent end-faces of the wall elements, and the other joining element has an opposite contour that glides on the diagonal bounding surface when the wall elements are mutually aligned.

According to the method according to the invention for mutual joining of wall elements of an elevator car, arranged in the area of adjacent end-faces of two respective wall elements are two joining elements, of which one is fixed on a principal surface of a first wall element and the other on a principal surface of a second wall element that lies in the same plane, each joining element also overlapping the principal surface of the wall element to which it is not fixed. Present on a joining element is a bounding surface that runs diagonal to the longitudinal direction of the adjacent end-faces of the wall elements which on pressing together of the wall elements acts in conjunction with an opposite contour of the other joining element in such manner that the wall elements are positioned with a gap of defined width between their adjacent end-faces.

The advantages that are obtained through the invention are principally to be seen in that the wall elements can be installed and joined together easily and without aids from inside the elevator car even though the joining elements are fastened on the side of the wall elements that faces away from the interior, that the outside of the elevator car need not be accessible, that the junction consists of only two very simple and inexpensive joining elements that are already joined to the wall elements at the factory, and that the junction can be executed with or without a gap between the wall elements.

Advantageous embodiments and further developments of the invention are described below.

According to another embodiment of the invention, the diagonally running bounding surface of the one joining element, and the opposite contour of the other joining element, are executed in such manner that a movement of the second wall element out of a position that, in the lengthwise direction of the adjacent end-faces, is offset relative to the first wall element, into the intended not-offset position, results in a sliding movement of the opposite contour of the other joining element on the diagonal adjacent surface of the one joining element and thereby a defined mutual positioning of the wall elements.

Advantageously, the angle α that is present between the lengthwise direction of the adjacent end-faces and the diagonal bounding surface of the one joining element is 20° to 70°.

A particularly certain and precise positioning of the wall elements is attained when the angle a that is present between the lengthwise direction of the adjacent end-faces and the diagonal bounding surface of the one joining element is 30° to 600°.

Particularly stable mutual positioning of the wall elements with or without an intervening gap can be obtained with an embodiment of the invention in which the contours that act in conjunction with the joining elements have at least one approximately vertical locking surface which at the end of the sliding movement of the opposite contour on the diagonal bounding surface mutually locks the joining elements, and thereby the wall elements, as a result of which a gap of defined width between the adjacent end-faces of the wall elements is assured.

According to yet another embodiment of the invention, both of the joining elements are fixed on the principal surfaces of the two wall elements that face away from the inside of the elevator car. As a result, the side of the wall elements that faces the inside can serve as a car inside wall without additional cladding.

Expediently, different heights and rigidities of the wall elements are taken into account by two wall elements being mutually aligned by means of one or by means of several joining devices.

Advantageously, the wall elements are present in the form of composite (sandwich) panels, metal sheets, or plastic panels.

According to a particularly expedient embodiment of the method according to the invention, a second wall element is mutually aligned to an already positioned first wall element, in that the second wall element is so mutually aligned relative to the first wall element that adjacent end-faces run approximately parallel, that the corresponding principal surfaces of the two wall elements are flush, and that the joining elements overlap the principal surfaces to which they are not fixed. As a result, the wall element that is to be mutually aligned is lowered from a somewhat raised position relative to the other wall element into its final position. The diagonal bounding surface of the one joining element guides the opposite contour of the other joining element in such manner that the wall elements are positioned with a gap of defined width between their adjacent end-faces.

Another embodiment of the method according to the invention includes the joining elements being made and fixed to the wall elements in such manner that the wall elements are positioned with a defined gap-width of 0 to 30 mm between their adjacent end-faces.

Particularly versatile use of the method according to the invention is made possible by the wall elements being mutually aligned and installed from inside the elevator car, the joining elements being inaccessible to the person performing the installation.

Particularly efficient and installation-friendly is an embodiment of the method in which the wall elements that are mutually aligned are first held vertical by grooves in floor-frame sections and subsequently fixed by their upwardly lying edges in grooves of a roof-frame section.

Other features and advantages of the present invention will become apparent from the following description of the invention that refers to the accompanying drawings.

### BRIEF DESCRIPTION OF THE DRAWINGS

FIG. 1 is a cross section through an elevator system according to the invention with an elevator car according to the invention;

FIG. 2 shows an elevator car according to the invention with car walls that each comprise several wall elements that are joined by joining devices according to the invention;

FIG. 2A is an enlarged view of the joining device according to the invention;

FIG. 3A is an illustration of the procedure for installing two adjacent wall elements on a car floor;

FIG. 3B is an illustration of two wall elements that are joined together with the joining device according to the invention and guided in grooves in the car floor and in the roof frame;

FIGS. 4A, 4BE, 4C are illustrations of the interaction of joining elements according to the invention during installation of two adjacent wall elements;

FIG. 5 shows joining elements according to the invention with locking surfaces for the gapless locking of the wall elements;

FIG. 6 shows joining elements according to the invention with two pairs of locking surfaces to lock the wall elements with intervening gap of defined width.

### DETAILED DESCRIPTION OF THE INVENTION

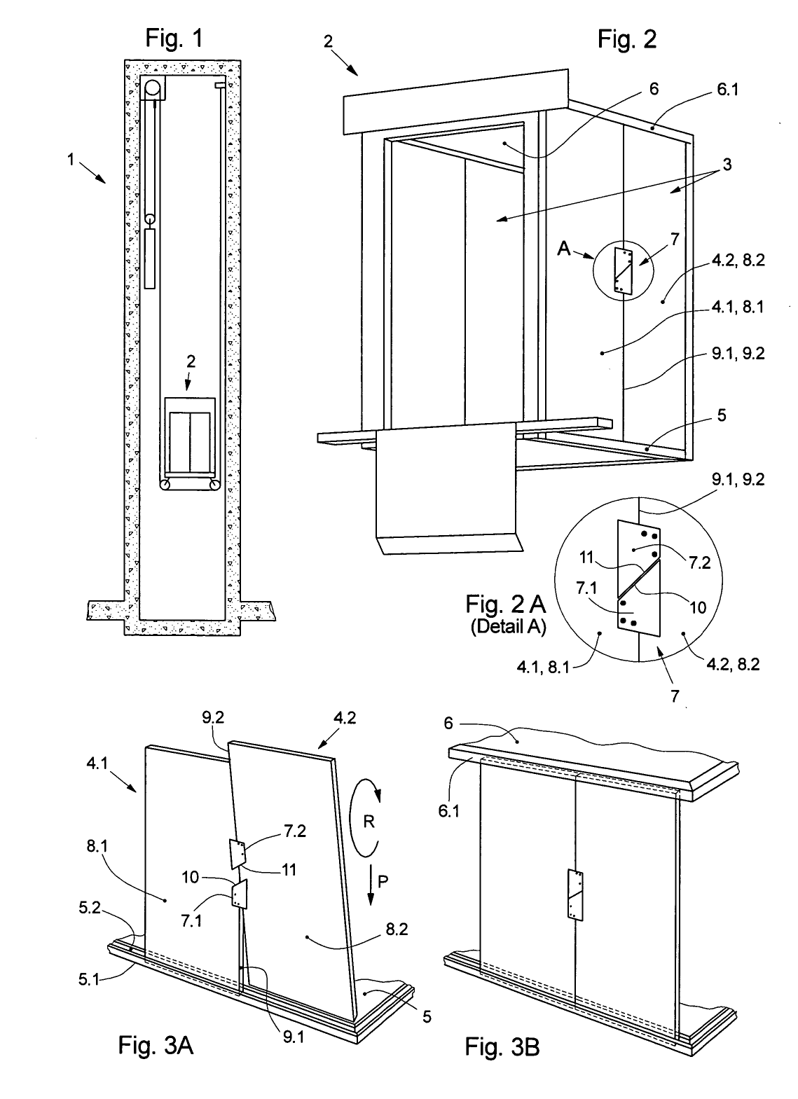

FIG. 1 shows an elevator car 2 according to the invention that is installed in an elevator system 1.

FIG. 2 shows an illustration of the elevator car 2 with car walls 3, each of which comprises two panel-shaped wall elements 4.1 and 4.2. The panel-shaped wall elements 4.1, 4.2 are preferably executed as compound (sandwich) elements but can also be present in the form of compact metal or plastic panels. At least at their lower and upper edges the wall elements 4.1, 4.2 are guided on a floor-frame section 5.1 of the car floor 5, and on a roof-frame section 6.1 of the car roof 6 respectively, these frame sections being preferably made from drawn aluminum sections with integrated grooves. On their side that faces away from the inside of the elevator car 2, in the area of their adjacent end-faces 9.1, 9.2, the wall elements 4.1, 4.2 are joined by means of a joining device 7 that is shown enlarged in FIG. 2A. The joining device 7 consists of two joining elements 7.1 and 7.2 that are arranged one above the other. A first joining element 7.1 is fixed on a principal surface 8.1 of a first wall element 4. 1, and a second joining element 7.2 is fixed on a second principal surface 8.2 of a second wall element 4.2 that is flush with the principal surface 8.1 of the first wall element 4. 1, each joining element also overlapping the principal surface of the wall element to which it is not fixed. The joining elements 7.1, 7.2 that are fixed to the wall elements 4.1, 4.2 in the described manner have the effect that, in the area of the joining elements, the wall elements are exactly mutually aligned and flush with each other. Fixing of the joining elements 7. 1, 7.2 onto the wall elements 4.1, 4.2 can be effected by, for example, adhesive bonding, rivets, screw fasteners, etc. In all of the figures, the fixing is indicated in each case by three black dots that symbolize, for example, three screw fasteners or three rivet fasteners.

The first joining element 7.1 has a bounding surface 10 that runs diagonal to the lengthwise direction of the adjacent end-faces 9.1, 9.2 of the wall elements 4.1, 4.2, and that is referred to hereafter as diagonal bounding surface 10. The second joining element 7.2 has an opposite contour 11 which during mutual alignment of the wall elements acts in conjunction with the diagonal bounding surface 10 of the first joining element in such manner that the two wall elements 4.1, 4.2 move toward each other until a gap of defined width between the adjacent end-faces 9.1, 9.2 is attained. For this to take place, it is not necessary for the longitudinal direction of the adjacent end-faces of the two wall elements to run vertically.

In the embodiment shown in FIG. 2, the opposite contour 11 of the second joining element 4.2 consists of a surface that is parallel to the diagonal bounding surface 10 of the first joining element. This embodiment is particularly suitable for car walls in which no gap (gap-width practically zero) is foreseen between adjacent wall elements. The opposite contour can, however, also have a different shape, for example as shown in FIGS. 5 and 6.

FIGS. 3A and 3B show the interaction of the diagonally running bounding surface 10 of the first joining element 7.1 with the opposite contour 11 of the second joining element 7.2 during alignment and installation of the wall elements as described above. In the situation according to FIG. 3A, a first wall element 4.1 is already placed in a groove 5.2 of a floor-frame section 5.1 of the car floor 5, and a second wall element 4.2 is just on the point of being mutually aligned with the first. For this purpose, the second wall element 4.2 is raised by several centimeters relative to the first wall element 4.1, its principal surface 8.2 being held slightly sloping relative to the principal surface 8.1 of the first wall element. Subsequently, the distance between the adjacent end-faces 9.1, 9.2 of the two wall elements is reduced to such an extent that each of the two joining elements 7.1, 7.2 overlaps the principal surface of the respective wall element to which it is not fixed. Hereupon, the second wall element 4.2 is brought into approximately vertical position (swiveling movement R) so that each of the two joining elements lies on the principal surface of the respective wall element to which it is not fixed, as a result of which the two wall elements 4.1, 4.2 become flush with each other. Finally, the second wall element 4.2 is lowered to the level of the first wall element 4.1, i.e. into the groove 5.2 in the floor-frame section 5.1 (lowering movement P). In the process of this lowering movement, the opposite contour 11 of the second joining element 7.2 enters into contact with the diagonal bounding surface 10 of the first joining element 7.1, whereby a horizontal component of movement is imparted to the second joining element in such manner that the second wall element 4.2 that is being mutually aligned moves toward the first wall element 4.1 until a gap of defined width, which can also be zero, is attained.

When the wall elements are being mutually aligned during installation, the wall elements 4.1, 4.2 are held at their lower edges by grooves 5.2 in floor-frame sections 5.1 of the elevator floor 5. When all wall elements including the car front of the elevator car 2 have been mutually aligned, the upper edges of the wall elements 4.1, 4.2 are fixed with the aid of a roof-frame section 6.1, preferably in grooves that are present in the roof-frame section 6.1. This fixing prevents lifting of the wall elements 4.1, 4.2, and thereby decoupling of the wall elements that are coupled to each other by the joining elements. This situation is shown in FIG. 3B.

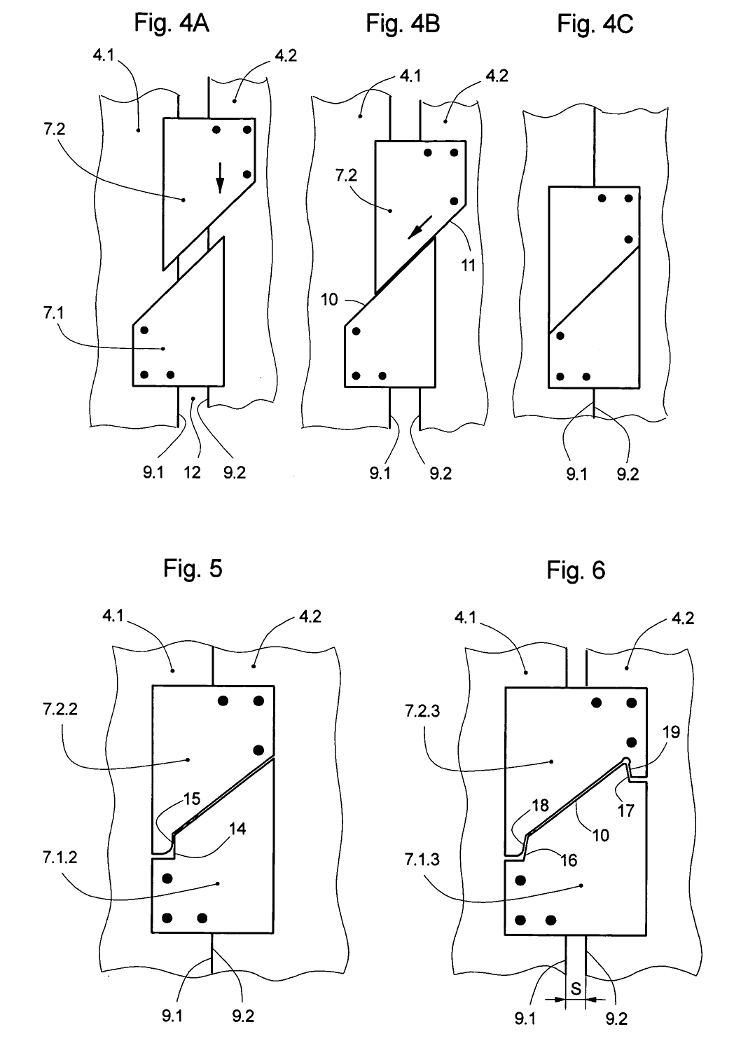

In FIGS. 4A, 4B, 4C, the interaction of the joining elements 7.1, 7.2 during mutual alignment of the wall elements 4.1, 4.2 is illustrated in even greater detail. FIG. 4A shows the situation of the joining elements 7.1, 7.2 after the wall elements 4.1, 4.2 that are to be mutually aligned have been aligned flush relative to each other as described above. The wall element 4.2 is slightly raised relative to the wall element 4.1 and each of the two joining elements 7.1, 7.2 overlaps the principal surface of the wall element to which it is not fixed. Present between the adjacent end-faces 9.1, 9.2 of the wall elements is a starting gap 12. In a first step, the second wall element 4.2 along with the second joining element 7.2 that is fixed to it is lowered until it is approximately parallel to the lengthwise direction of the adjacent end-faces 9.1, 9.2 of the wall elements, until the opposite contour 11 of the second joining element strikes the diagonal bounding surface 10 of the first joining element 7.1 as shown in FIG. 4B. If the second wall element 4.2 is now lowered further, the opposite contour 11 of the second joining element 7.2 slides along the diagonal bounding surface 10 of the first joining element until the second wall element 4.2 has reached the same level as the first. During lowering, the width of the starting gap 12 that is present between the end-faces 9.1, 9.2 of the two wall elements is reduced until the wall elements have reached their foreseen relative position. In the. present example, during lowering, the width of the starting gap 12 is reduced to practically zero, i.e. the adjacent end-faces 9.1, 9.2 of the two wall elements 4.1, 4.2 rest against each other without gap. This situation is shown in FIG. 4C.

FIG. 5 shows a variant embodiment of joining elements 7.1.2 and 7.2.2 according to the invention in which the mutual fixing of the wall elements 4.1, 4.2 with closed gap (gap-width zero) between the adjacent end-faces 9.1, 9.2 of the wall elements is secured in that after reaching their foreseen end position, the two joining elements mutually lock themselves, and thereby the wall elements, in the horizontal direction. In the embodiment shown in FIG. 5, the mutual locking takes place through a contour of the first joining element 7.1.2 in the form of an approximately vertical locking surface 14 acting in conjunction with a contour of the second joining element 7.2.2 which is also present in the form of an approximately vertical locking surface 15. Such a locking has the advantage that the mutual horizontal position of the wall elements is still sufficiently accurate and always defined when the vertical mutual alignment by means of the floor-frame section 5.1, and the roof-frame section 6.1, does not assure this on account of manufacturing tolerances on all components involved.

FIG. 6 shows a further embodiment of joining elements 7.1.3, 7.2.3 according to the invention that has the same advantages as the embodiment according to FIG. 5 but that additionally allows mutual alignment and installation of two wall elements 4.1, 4.2 with a gap of defined width S between their adjacent end-faces 9.1, 9.2. This is achieved through the joining elements 7.1.3, 7.2.3 having interacting contours over which the joining elements 7.1.3, 7.2.3, after reaching their foreseen final position, lock each other in the horizontal direction. In the embodiment that is shown in FIG. 6, the contours that effect the locking consist of two approximately Vertical locking surfaces 16, 17 of the first joining element 7.1.3 and two also approximately vertical locking surfaces 18, 19 of the second joining element 7.2.3. Advantageously but not necessarily, such locking surfaces 16 to 19 are arranged in the area of one or both ends of the diagonal bounding surface 10. With such a locking that acts in both horizontal directions, two wall elements can be joined stably and play-free with an intervening gap of defined, freely selectable width S, preferably with a gap-width S of 0 to 30 mm. Such gaps can, for example, be provided as ventilation slits to ventilate the elevator car.

Two laterally mutually aligned wall elements can also be joined together by several joining points arranged one above the other, each of the joining points consisting of the two respective joining elements described above.

The diagonal bounding surface of the one joining element that acts in conjunction with a respective opposite contour of the other joining element need not necessarily be a flat surface. It could, for example, be advantageous if its slope increases at the end of the aligning movement.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. An elevator car comprising: at least one car wall that includes at least two adjacently arranged wall elements; and two joining elements present in an area of adjacent end-faces of the wall elements, one of the joining elements being fixed on a principal surface of a first of the wall elements, and the other of the joining elements being fixed on a principal surface of a second of the wall elements, each of the joining elements being arranged to also overlap the principal surface of the wall element on which the joining element is not fixed, one of the joining elements having a bounding surface that is diagonal relative to a longitudinal direction of the adjacent end-faces of the wall elements and the other of the joining elements having an opposite contour which on mutual alignment of the wall elements slides along the diagonal bounding surface.

2. The elevator car according to claim 1, wherein the diagonal bounding surface of the one joining element and the opposite contour of the other joining element are formed so that during mutual alignment of the wall elements a movement of the second wall element out of a position that is offset in the longitudinal direction of the adjacent end-faces relative to the first wall element into a not-offset position results in a sliding movement of the opposite contour of the other joining element along the diagonal bounding surface of the one joining element and thereby a mutual positioning of the wall elements with a defined gap-width between their adjacent end-faces.

3. The elevator car according to claim 2, wherein an angle (α) that is present between the longitudinal direction of the adjacent end-faces and the diagonal bounding surface of the one joining element is 20° to 70°.

4. The elevator car according to claim 3, wherein the angle (α) that is present between the longitudinal direction of the adjacent end-faces and the diagonal bounding surface of the first joining element is 300° to 600°.

5. The elevator car according to claim 1, wherein the joining elements have interacting contours with at least one approximately vertical locking surface that locks the joining elements and thereby the wall elements with a gap of defined width between their adjacent end-surfaces.

6. The elevator car according to claim 1, wherein the joining elements are fixed on the principal surfaces of the two wall elements that face away from an inside of the elevator car.

7. The elevator car according to claim 1, wherein the two interacting joining elements form a joining device several of the joining devices being provided to mutually align two wall elements.

8. The elevator car according claim 1, wherein the wall elements are one of compound (sandwich) panels, metal sheets, or plastic panels.

9. A method of installing wall elements of an elevator car, comprising the steps of: arranging two joining elements in an area of adjacent end-faces of two adjacently installed wall elements so that one of the joining elements is fixed on a principal surface of a first wall element and the other of the joining element is fixed on a principal surface of a second wall element, and so that each joining element also overlaps the principal surface of the wall element to which the joining element is not fixed, one of the joining elements having a bounding surface that is diagonal to a longitudinal direction of the adjacent end-faces of the wall elements; and aligning the wall elements so that the bounding surface acts in conjunction with an opposite contour of the other joining element so that the wall elements are positioned with a gap of defined width between their adjacent end-faces.

10. The method according to claim 9, including mutually aligning a second wall element to an already positioned first wall element, wherein the second wall element is mutually aligned relative to the first wall element so that adjacent end-faces run substantially parallel, so that the corresponding principal surfaces of the two wall elements are flush with each other, and so that the joining elements overlap the principal surfaces to which they are not fixed, whereby the second wall element is lowered from a somewhat raised position relative to the first wall element into a final position, the diagonal bounding surface of the one joining element guiding the opposite contour of the other joining element so that the wall elements are positioned with a gap of defined width between their adjacent end-faces.

11. The method according to claim 10, wherein the joining elements are made and fixed onto the wall elements so that the wall elements are positioned with a defined gap-width of 0 to 30 mm between their adjacent end-faces.

12. The method according to claim 11, wherein the wall elements are mutually aligned and installed from inside the elevator car, the joining elements not being accessible to a person performing the installation.

13. The method according to claim 9, including first holding the wall elements upright at their lower edges by grooves in floor-frame sections and subsequently holding the wall elements on their upper edges in grooves of roof-frame sections.

14. An elevator system comprising an elevator car having at least one car wall that includes at least two adjacently arranged wall elements; and two joining elements present in an area of adjacent end-faces of the wall elements, one of the joining elements being fixed on a principal surface of a first of the wall elements, and the other of the joining elements being fixed on a principal surface of a second of the wall elements, each of the joining elements being arranged to also overlap the principal surface of the wall element on which the joining element is not fixed, one of the joining elements having a bounding surface that is diagonal relative to a longitudinal direction of the adjacent end-faces of the wall elements and the other of the joining elements having an opposite contour which on mutual alignment of the wall elements slides along the diagonal bounding surface.
